(19) United States
(12) Patent Application Publication
(10) Pub. No.: US 2010/0110877 A1
(43) Pub. Date: May 6, 2010

(54) SYSTEM AND METHOD FOR FAILOVER OF MOBILE UNITS IN A WIRELESS NETWORK

(75) Inventor: Puneet BATTA, Sunnyvale, CA (US)

Correspondence Address: INGRASSIA FISHER & LORENZ, P.C. (Symbol), 7010 E. COCHISE ROAD, SCOTTSDALE, AZ, 85253-1406, US

(73) Assignee: SYMBOL TECHNOLOGIES, INC., Holtsville, NY (US)

(21) Appl. No.: 12/261,886

(22) Filed: Oct. 30, 2008

(51) Int. Cl. H04W 24/00; H04W 36/00; H04L 12/24

(52) U.S. Cl. 370/216; 370/331

(57) ABSTRACT

A method of handling a discontinuation of service from a wireless access device is provided. The first wireless access device has a first basic service set identifier and communicates with a plurality of mobile units using a first channel. The method comprises transmitting a first service notice with a second wireless access device using the first channel, wherein the first service notice containing information instructing the first plurality of mobile units to transfer to a second channel for service, and providing service to the first plurality of mobile units using the second channel.

### TECHNICAL FIELD

Embodiments of the subject matter described herein relate generally to communication between wireless access devices and mobile units. More particularly, embodiments of the subject matter relate to failover between access devices.

### BACKGROUND

A wireless connection to a computer network is vital for mobile units to permit them to exchange information among themselves or with other systems connected the network. Such connectivity is typically provided through wireless access devices. Wireless access devices are usually stationary and provide service to mobile units within range of wireless communication with them.

Mobile units are frequently within range of more than one wireless access device. During normal operation, a mobile unit associates itself with one wireless access device for continuous service. Typically the association manifests itself through the mutual use of a designated channel for wireless communication, as well as use by the wireless access device of a unique identifier to prevent ambiguity as to the identity of the transmitting entity or the intended recipient of a particular message.

Because no network device is infallible, under certain circumstances, a wireless access device can cease to operate—provide wireless service to mobile units—permanently or temporarily. In the event of such a service discontinuation, a mobile unit associated with the wireless access device will typically spend a period of time attempting to re-establish contact with the failed wireless access device. After a predetermined length of time attempting to contact the non-responsive wireless access device, the mobile unit will attempt to establish service with a new wireless access device. During the period of re-establishment attempts, the mobile unit will be unable to communicate with other network devices, which can impair performance of the mobile unit.

### BRIEF SUMMARY

A method of handling a discontinuation of service from a wireless access device is provided. The first wireless access device has a first basic service set identifier (BSSID) and communicates with a plurality of mobile units using a first channel. The method comprises transmitting a first service notice with a second wireless access device, wherein the first service notice containing information instructing the first plurality of mobile units to transfer to a second channel for service, and providing service to the first plurality of mobile units using the second channel.

A method of providing service to a plurality of mobile units is also provided. The method comprises providing service from a first wireless access device using a first channel, the first wireless access device controlled by a system controller and communicating with the plurality of mobile units using a first BSSID, detecting an interruption of service from the first wireless access device with the system controller, transmitting a first channel switch notice with a second wireless device using the first BSSID, the first channel switch notice containing information instructing a first group of the plurality of mobile units to communicate with the second wireless access device using a second channel, and providing service from the second wireless access device using the second channel.

A system for providing wireless communication service to a plurality of mobile units is also provided. The system comprises a first wireless access device adapted to provide wireless communication service to the plurality of mobile units, the first wireless access device having a first BSSID and adapted to communicate with the plurality of mobile units using a first channel, a second wireless access device adapted to provide wireless service to the plurality of mobile units using the first BSSID and adapted to communicate with the plurality of mobile units using the first channel and a second channel, and a system controller adapted to detect an operational state of the first wireless access device and to operate the second wireless access device to transmit a channel switch notice in response to detecting a discontinuation of service from the first wireless access device, the channel switch notice conveying information instructing the plurality of mobile units to communicate with the second wireless access device using the second channel.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic illustration of a wireless network in a first operating state;

FIG. 2 is a schematic illustration of the wireless network of FIG. 1 in a second operating state; and

FIG. 3 is a flowchart that illustrates a method of failover for a wireless network providing service to a mobile device.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components and with reference to symbolic representations of operations, processing tasks, and functions that may be performed by various computing components or devices. In practice, one or more processor devices can carry out the described operations, tasks, and functions by manipulating electrical signals representing data bits at memory locations in the system memory, as well as other processing of signals. It should be appreciated that the various block components shown in the figures may be realized by any number of hardware, software, and/or firmware components configured to perform the specified functions.

Certain terminology may also be used in the following description for the purpose of reference only, and thus are not intended to be limiting. For example, terms such as “first”, “second” and other such numerical terms referring to structures do not imply a sequence or order unless clearly indicated by the context.

For the sake of brevity, conventional techniques related to signal processing, wireless data transmission, signaling, wireless network infrastructure components, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

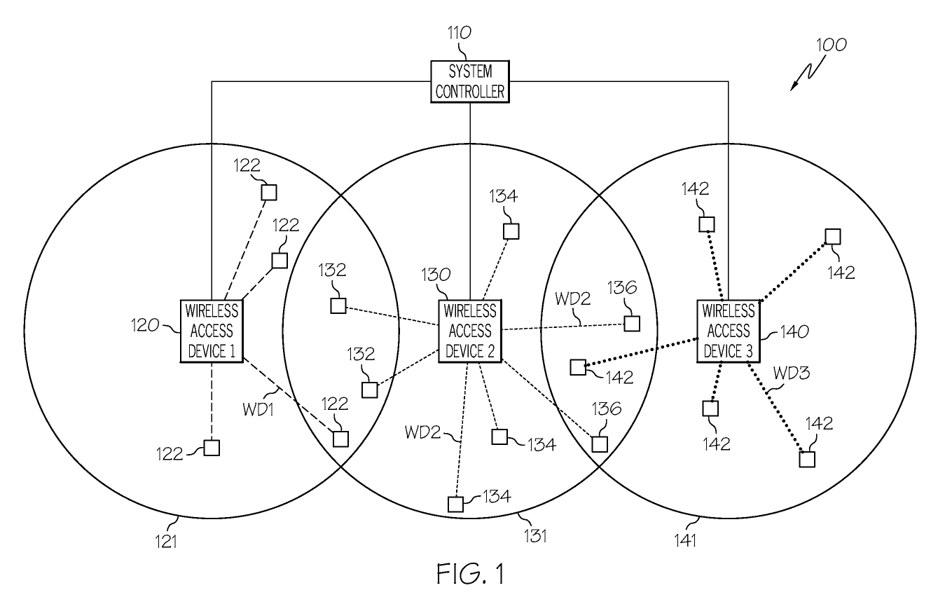

FIG. 1 illustrates an exemplary embodiment of a wireless network 100. The wireless network 100 comprises a system controller 110, first, second, and third wireless access devices 120, 130, 140, and a plurality of mobile units 122, 132, 134, 136, 142. The system controller 110 controls each wireless access device 120, 130, 140, through which it can provide wireless network connectivity to each of the mobile units 122, 132, 134, 136, 142. Each wireless access device 120, 130, 140 has a respective wireless range 121, 131, 141 within which it can provide wireless service to the mobile units 122, 132, 134, 136, 142. For simplicity and ease of description, the wireless network 100 is depicted with only three wireless access devices. In practice, the wireless network 100 may include any number of wireless access devices, each configured to support any number of mobile units.

The system controller 110 is preferably a network device such as a switch, router, or other traffic-directing component. Although the system controller 110 can be embodied as various devices, it preferably includes components necessary to perform the operations and features of the systems and methods described herein. As one non-limiting example, a system controller can comprise a suitably configured processor, memory, and functional modules, such as a wireless transceiver, as well as any other device or component necessary or desirable to enable performance of the role described. The system controller 110 can transmit and receive network signals from devices to which it is coupled. Additionally, the system controller 110 can be adapted to operate other devices, including the each wireless access device 120, 130, 140, to which it is coupled. Accordingly, the system controller 110 can monitor, regulate, and control the communication of wireless network signals to and from the mobile units 122, 132, 134, 136, 142. In certain embodiments, the system controller 110 communicates with the wireless access devices 120, 130, 140 using conventional network interconnects and data communication protocols. For example, the system controller 110 can utilize known Ethernet data communication techniques and suitably configured network cables for communication with the wireless access devices 120, 130, 140.

Although not shown with additional couplings, the system controller 110 can be coupled to other network components, thereby providing it with network access to the Internet, to an intranet, or to any other network appropriate to the embodiment. The system controller 110 can be embodied as a network component, or a portion thereof, such as a controller submodule of a network component, or a submodule of another device coupled to, and in communication with, a network component, such as those described above.

Each wireless access device 120, 130, 140 is preferably a wireless access point or access port adapted to provide wireless network connectivity to one or more wireless access devices. Regardless of the specific type of wireless access device, each preferably includes components necessary to perform the operations and features of the systems and methods described herein. Accordingly, each wireless access device preferably comprises a suitably configured processor, memory, and functional modules, such as a wireless transceiver, as well as any other necessary device or component. Certain embodiments of wireless access devices can further comprise wired network connections capable of providing network connectivity to fixed connection devices. The first wireless access device 120 can communicate with mobile units through conformity with one or more of the IEEE 802.11 family of standards, or through other standards appropriate to the embodiment. Preferably, each wireless access device 120, 130, 140 provides a pathway through which the mobile units it services can exchange network signals to remote network participants. Although an approximate wireless range 121, 131, 141 is shown, respectively, for each wireless access device 120, 130, 140, the operating range of a wireless access device need not be symmetric, and the ranges illustrated are for exemplary explanation of service areas, including at least partially overlapping service areas, and the mobile units disposed therewithin, as explained further below.

Each wireless access device 120, 130, 140 can communicate with a mobile unit using a standard wireless channel, such as one specified in a channel list associated with a protocol in the IEEE 802.11 family. In accordance with standard wireless networking practice, each wireless access device 120, 130, 140 can communicate with an identifier denoting itself in wireless communications. Such an identifier, such as a basic service set identifier (BSSID) can be used by receiving wireless access devices to determine whether information from the transmitting source is useful or appropriate to wireless communication by the receiving device. Other identifiers, designating either a name, description of the wireless device, or other means of distinguishing among the wireless devices can also be used.

As one example, which will be explored in greater detail below, one of the group of mobile units 122 can be associated with the first access wireless access device 120, and can respond to signals from the first wireless access device 120 at least in part because they contain a BSSID identifying the first wireless access device 120. Additionally, when transmitting a signal destined for a remote network participant, a mobile unit can indicate which wireless access device it is associated with, and receives wireless service from, by including the BSSID of the wireless access device for which the signal is intended. Each wireless access device can operate with a unique BSSID. Devices with different BSSIDs can operate on a shared network. The shared network can be uniquely identified using a service set identifier (SSID). Multiple wireless access devices with distinct BSSIDs can operate on a single network with one SSID. Each wireless access device 120, 130, 140 can be configurable to use any BSSID, though preferably a different BSSID is used with each device to provide a unique identifier. One example of a unique BSSID for a wireless access device can be the media access control (MAC) address used by the wireless access device to participate on some networks. Additionally, in some embodiments, the wireless access devices 120, 130, 140 can be configured to identify itself with different BSSIDs on different wireless channels.

In certain embodiments, the first, second, and/or third wireless access devices 120, 130, 140 can be independently-operating wireless service providers. In such embodiments, the wireless access devices 120, 130, 140 are not coupled to a system controller. Each independent wireless access device can be capable of directing wireless network signals to and from any mobile units supported by the wireless access device. Additionally, each wireless access device preferably can detect and monitor signals from neighboring wireless access devices. Detection can include detection of such information as the channel and the BSSID used by the neighboring wireless access device, including those operating on a same-SSID network, collectively referred to as service information. Thus, although the system controller 110 is present in some embodiments, it is omitted in others where the wireless access devices independently perform at least some of the functions of the system controller 110.

Each wireless access device 120, 130, 140 can operate in several states, including a normal operating state. Under certain circumstances, however, a wireless access device can experience a service failure. One example of a service failure can be the result of a loss of electrical power to the wireless access device. In another example, the wireless access device could experience a hardware or software failure, inhibiting its proper operation and preventing wireless service to mobile units serviced by the wireless access device. Typically service failure is remedied through external action, such as reconfiguring the device to overcome the hardware or software malfunction or resupplying power to the wireless access device.

Another operating state in which a wireless access device can be placed is that of service interruption, during which the wireless access device is functional, but temporarily unable to provide wireless connectivity to mobile units. One example of service interruption can be radiofrequency interference sufficient to interrupt service. Typically, service interruptions do not require action affecting the wireless access device to restore service.

The service failure state and service interruption state can be broadly categorized as service discontinuation, wherein wireless service is not provided to mobile units serviced by the wireless access device. After either occurs, wireless service from the wireless access device can resume after the conditions causing the service discontinuation are remedied. Other types of service discontinuation not explicitly listed above are also contemplated.

A plurality of mobile units 122, 132, 134, 136, 142 is each serviced by one of the wireless access devices 120, 130, 140. The mobile units 122, 132, 134, 136, 142 can be any sort of wireless access device, including personal digital assistants, mobile computing platforms, integrated multifunction devices, such as bar code scanners with wireless information exchange, and so on. Preferably, regardless of the specific embodiment, each mobile unit preferably includes components necessary to perform the operations and features of the systems and methods described herein. Accordingly, each mobile unit preferably comprises a suitably configured processor, memory, and functional modules, such as a wireless transceiver, as well as any other necessary device or component. Although referred to as mobile units, in some embodiments, they can be stationary wireless network clients cooperating with one of the wireless access devices 120, 130, 140 for network connectivity. A mixture of device types can also be present in a wireless network.

At any given moment in time, a first group of mobile units 122 can be serviced by, or associated with, the first wireless access device 120, as shown. Although one layout of mobile units 122 is shown, the mobile units or other devices serviced by the first wireless access device 120 can vary over time. FIG. 1 illustrates communication between mobile units 122 and first wireless access device 120 with a distinguishable line pattern (long dashes). The line pattern indicates that the first wireless access device 120 uses a unique BSSID to interact with the mobile units. As expected, the first wireless access device 120 can only provide service to those mobile units 122 within its wireless range 121. Although some mobile units 122 are disposed within the wireless range 131 of the second wireless access device 130, they are associated with the first wireless access device 120, as shown.

The long-dashed line illustrating communication between the first wireless access device 120 and the mobile units 122 indicates, among other aspects, the use of the BSSID “WD1” by the first wireless access device 120 in communications with the mobile units 122. Although WD1 is used for exemplary purposes, different BSSIDs can be used by wireless access devices, including the first wireless access device 120, where desired. As can be seen, one of the mobile units 122 is disposed within the ranges 121, 131 of both the first and second wireless access devices 120, 130. The long-dashed line is distinct from the short-dashed line used to illustrate the association of certain mobile units 132 with the second wireless access device 130, as described in greater detail below. It should be appreciated that the mobile units 122 associated with the first wireless access device 120 preferably use a different channel for communication than those 132, 134, 136 associated with the second wireless access device 130.

The second wireless access device 130 provides wireless service to three groups of mobile units 132, 134, 136, as can be seen by the short-dashed lines illustrating communication therebetween. The first group 132 includes mobile units disposed within the wireless ranges 121, 131 of the first and second wireless access devices 120, 130. The second group 134 includes mobile units disposed only within the wireless range 131 of the second wireless access device 130. The third group 136 includes mobile units disposed with the wireless ranges 131, 141 of the second and third wireless access devices 130, 140. All of the mobile units 132, 134, 136 are associated with the second wireless access device 130, and utilize it for wireless network connectivity. The third wireless access device 140 is substantially similar to the first wireless access device 120 for purposes of discussion and illustration.

While the short-dashed line indicates an association between the mobile units 132, 134, 136 and the second wireless access device 130, including the use of the BSSID WD2 by the second wireless access device 130, the circle-dashed line indicates the association between the third wireless access device 140 and mobile units 142. The short-dashed line further indicates the use of a BSSID unique to the second wireless access device 130, “WD2”, while the circle-dashed line indicates the use of the unique BSSID “WD3” by the third wireless access device 140.

Each mobile unit 122, 132, 134, 136, 142 preferably communicates with its respective wireless access device 120, 130, 140 using a separate channel for each device to prevent interference. The appropriate channel can be indicated as part of the practiced protocol. Similarly, each wireless access device 120, 130, 140 can operate on its individual channel using a separate SSID. As previously described, for exemplary purposes, the BSSID WD1 will be used in conjunction with the first wireless access device 120, and the BSSIDs WD2 and WD3 with the second and third wireless access devices 130, 140 respectively.

Under certain circumstances, a wireless access device can experience a service discontinuation. During the cessation of wireless service, any mobile units associated with the wireless access device will experience a “retry” period during which they attempt to re-establish contact with the wireless access device. Subsequently, they can attempt to establish contact with a new wireless access device to regain network connectivity. This procedure can be longer than desirable for systems and circumstances where reliable data transfer is preferred.

The inability of a wireless access device to provide service can occur for a variety of reasons, including power disruption, device failure, interference, and the like. Certain of these events can be detected by the system controller 110 by monitoring the operating state of the wireless access devices to which it is coupled. For example, the system controller 110 can be adapted to continuously monitor the functionality of each wireless access device to which it is coupled. If a wireless access device fails or otherwise experiences a wireless service discontinuation, the system controller 110 can initiate a failover. In those embodiments without a system controller 110, each wireless access device can monitor or detect the state of its neighboring devices. In the event a wireless access device detects a service discontinuation of a neighboring wireless access device, it can initiate a failover. For exemplary purposes, the second wireless access device 130 will be shown experiencing a service discontinuation. The failover plan can be initiated by the system controller 110 operating the remaining active wireless access devices 120, 140. In those embodiments without a system controller, each wireless access device can operate independently, as appropriate to the embodiment.

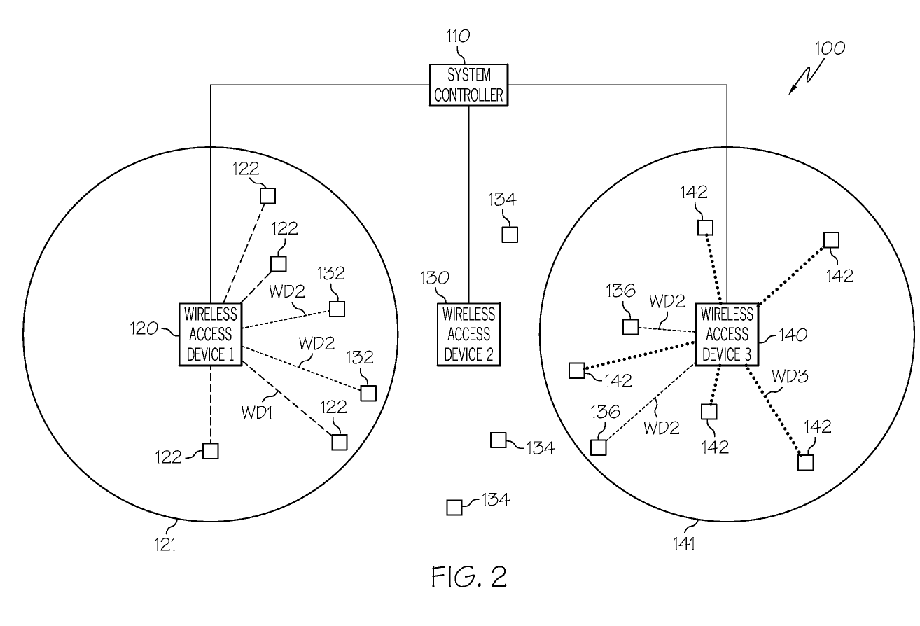

Thus, if a wireless access device discontinues service, a failover plan can be employed to reduce the interval of interrupted service. FIG. 2 illustrates some transmissions made to effect such a failover. As can be seen, the second wireless access device 130 has discontinued wireless service to mobile units with which it was associated. Consequently, those mobile units 132, 136 which are positioned within the wireless range 121, 141 of the first and third wireless access devices 120, 140 have had service provided for them by the respective wireless access devices 120, 140 to reduce or remove the interval of network access interruption and/or disruption.

As can be seen, the first wireless access device 120 communicates with the mobile units 132 within its wireless range 121. However, as FIG. 2 indicates, the first wireless access device 120 has contacted the mobile units 132 using the BSSID of second wireless access device 130, namely, WD2. Accordingly, the line indicating the association between the mobile units 132 and the first wireless access device 120 is short-dashed, indicating the contact retains commonality with the previous identity asserted by the second wireless access device 130. Thus, each mobile unit 132 is addressed as though by the second wireless access device 130. The first wireless access device 120 can than transmit information to the mobile units 132 instructing them to perform operations as though it was the wireless access device with which they have been associated, instead of a newly-contacting wireless access device, which it is.

As part of the service transition whereby the mobile units 132 failover to the first wireless access device 120, the first wireless access device 120 can take advantage of the multiple available channels for standard wireless connectivity. Under certain protocols, including the IEEE 802.11 family of protocols, different channels can be used by different wireless access devices to reduce or eliminate interference and cross-talk on a channel between multiple wireless access devices.

Thus, at the time of service discontinuation, the mobile units 132 are communicating with the second wireless access device 130 using a first channel and with the second wireless access device 130 using its BSSID, WD2. As part of the failover, the first wireless access device 120 can transmit a channel switch announcement notice, such as a channel switch announcement primitive from the 802.11h standard. The channel switch announcement notice or service notice can contain information instructing each mobile unit 132 within the wireless range 121 of the first wireless access device 120 that it should switch to a second channel, a different channel than the first channel which had been used by the second wireless access device 130.

Preferably, the channel switch announcement should be transmitted by the first wireless access device 120 using the first channel, and transmitted with the BSSID WD2. Accordingly, each mobile unit 132 can receive the notice from the first wireless access device 120 masquerading as the second wireless access device 130. Additionally, the channel switch announcement or channel switch notice can be repeated over a length of time, at regular or irregular intervals, to increase the likelihood that all mobile units associated with the transmitting—or masquerading—wireless access device receive the notice. As one non-limiting example, the channel switch notice can be repeated every 0.1 seconds for 1 second. After the 1 second has passed, the wireless access device and all mobile units associated with it will begin using the new channel for communication.

Thus, in the illustrated exemplary embodiment, the first wireless access device 120 can repeat transmission of the channel switch notice using BSSID WD2 over an interval, followed by transition of the mobile units 132 to the new channel. The preferred new channel for the transitioning mobile units 132 is the channel used by the first wireless access device 120 for communication with its associated mobile units 122. The failed-over mobile units 132 would use the same channel as the mobile units 122, as well as change their association to the first wireless access device 120. Thereafter, the first wireless access device 120 can communicate with the mobile units 132 using its own BSSID, WD1. The first wireless access device 120 preferably continues to provide service to the mobile units 122 associated with it unaffected by the failover sequence, as illustrated by the continued use of the long-dashed lines.

From the perspective of each mobile unit 132, the second wireless access device 130 appears to be instructing it to move to a second channel and switch service to the first wireless access device 120. In reality, however, the first wireless access device 120 is transitioning the mobile units 132 to a channel preferably used by the first wireless access device 120 in communicating with its own associated mobile units 122. Subsequently, the first wireless access device 120 can continue to provide wireless service to the mobile units 122, removing or reducing any lack of network connectivity for the mobile units 122. Such a channel switch can be similar to that of the IEEE 802.11h protocol for use in radar avoidance.

The third wireless access device 140 can perform a failover similar to that performed by the first wireless access device 120. As shown in FIGS. 1 and 2, some mobile units 136 associated with the second wireless access device 130 can be positioned within the wireless range 141 of the third wireless access device 140. During the service discontinuation of the second wireless access device 130, the third wireless access device 140 can transmit a channel switch announcement to the mobile units 136 using the BSSID of the second wireless access device 130, WD2, instead of its own, WD3. Thus, the communication to the mobile units 136 with the third wireless access device 140 using of the BSSID WD2 is illustrated through the use of the short-dashed lines. The mobile units 136 can then be serviced on the new channel, preferably the same channel with which the third wireless access device 140 communicates with the mobile units 142 it services, and adjust their association to the third wireless access device 140.

In this way, mobile units 132, 136 associated with the second wireless access device 130 are provided wireless service despite its service discontinuation by neighboring wireless access devices 120, 140. The system controller 110 can operate the first and third wireless access devices 120, 140 to effect the failover. Some mobile units 134 may be positioned outside the wireless ranges 121, 141 of either the first and/or third wireless access devices 120, 140. Accordingly, these mobile units 134 may experience a loss of service or, they may transition to other wireless access devices using a similar failover approach, if such devices are present.

After a period of time, the second wireless access device 130 may be restored to service. In those instances where the service discontinuation was temporary, the period of time may be short. On the other hand, if replacing the second wireless access device 130 is required for repair, it may be relatively longer. Regardless, resumption of service by the second wireless access device 130 may be detected by either the system controller 110 or an independent wireless access device, as appropriate to the embodiment. Subsequently, the first wireless access device 120 can initiate a restoration sequence, whereby the mobile units 132 are returned to service by and an association with the second wireless access device 130.

To transition the mobile units 132 back to service with the restored second wireless access device 130, the first wireless access device 120 can transmit a channel switch notice, similar to the one described above. The channel switch notice can contain information instructing the mobile units 132 to communicate with the transmitting wireless access device—here, represented to be the first wireless access device 120—using the original channel used by the second wireless access device 130. The channel switch notice to return mobile units 132 to the second wireless access device 130 can conform to any standard or protocol desired. Preferably, the channel switch notice distinguishes the mobile units 132 which were transitioned from the second wireless access device 130 from those mobile units 122 which had always been associated with the first wireless access device 120. Thus, only mobile units 132 are channel-switched and returned to association with the second wireless access device 130, and preferably not all mobile units associated with the first wireless access device 120. Such a channel switch notice can be part of a proprietary or custom-developed networking protocol, if desired, and need not conform to industry standards.

The first wireless access device 120 initiates the transition of the channel switch for the mobile units 132. Preferably, the first wireless access device 120 or system controller 110 has recorded information uniquely identifying which mobile units 132 have recently been transitioned. The first wireless access device 120 can then address the channel switch notices directly to only those mobile units 132. Thereafter, upon returning to the original channel, the mobile units 132 can communicate with the second wireless access device 130 in its normal operating state. The third wireless access device 140 can perform a return transition of the mobile units 136 it has failed-over back to the second wireless access device 130 in a similar manner. Subsequent to a return of mobile units 132, 134, 136 to service from the second wireless access device 130, the exemplary network appears in the state illustrated in FIG. 1.

The failover sequence described above can also be implemented in a self-healing network. In a self-healing network, service discontinuation by one wireless access device is remedied in the short term by transitioning affected mobile units to neighboring wireless access devices. The transitioned mobile units can later, as a longer-term solution, be re-associated with the neighboring wireless access device. Accordingly, the need for the failed wireless access device to service the affected mobile units is removed, representing the self-healing aspect of the network.

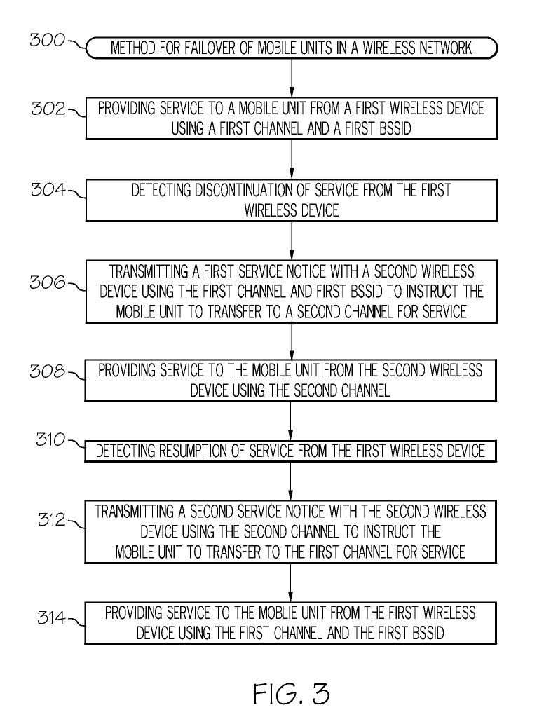

FIG. 3 is a flowchart illustrating the steps of a method practicable by the above-described systems to implement the described failover sequence. The various tasks performed in connection with method 300 below may be performed by software, hardware, firmware, or any combination thereof. For illustrative purposes, the following description of method 300 may refer to elements mentioned above in connection with FIGS. 1 and 2. In practice, portions of method 300 may be performed by different elements of the described system, e.g., system controller 110 and/or the wireless access devices 120, 130, 140. It should be appreciated that method 300 may include any number of additional or alternative tasks; the tasks shown in FIG. 3 need not be performed in the illustrated order, and method 300 may be incorporated into a more comprehensive procedure or process having additional functionality not described in detail herein.

During normal operation, a first wireless access device provides service to at least one mobile unit using a first channel (task 302). The first wireless access device uses a first BSSID to communicate with the mobile unit. Subsequently, the first wireless access device can experience a service discontinuation. The service discontinuation can be detected, either by a system controller coupled to the first wireless access device, or by a remote wireless access device monitoring the service information sent by the first wireless access device (task 304).

In response to detecting the service discontinuation, a neighboring, second wireless access device can transmit a first service notice using the first channel (task 306). Preferably, the second wireless access device transmits the first service notice using the first BSSID. The first service notice contains information instructing the mobile unit to transfer to a second channel, but continuing service. The first (and subsequent) service notice can be transmitted more than once, if desired.

After transmitting the first service notice, the second wireless access device can provide service to the mobile unit using the second channel (task 308). As part of the transition to the second channel, the mobile unit can alter its association to the second wireless access device. Subsequent communications between the second wireless access device and the mobile unit can be made with a second BSSID, unique to the second wireless access device. During this period, and throughout the operation of the second wireless access device, it can additionally provide wireless service to one or more other mobile units associated with it. Preferably, the second wireless access device uses the second channel for communication with its associated mobile units. Thus, by transitioning the first mobile unit to the second channel, the second wireless access device need only use a single channel to communicate with its own associated mobile units, as well as the new mobile unit from the first wireless access device.

At some later point, the first wireless access device may resume service. Preferably such resumption is detected, either by the system controller or by another wireless access device, such as the second wireless access device (task 310). In response to detecting the resumption of service, the second wireless access device can transmit a second service notice using the second channel (task 312). Preferably, the second service notice is sent addressed only the transitioned mobile unit, and not the mobile units which have always been associated with the second wireless access device. The second service notice contains information instructing the mobile unit originally associated with the first wireless access device to begin using the first, original channel for communication.

After the mobile unit returns to the first channel, the restored first wireless access device can resume providing service to it using the first channel and, appropriately, the first BSSID (task 314). In this way, the mobile unit associated with the first wireless access device fails over to the second wireless access device for service upon a service discontinuation by the first wireless access device. Thus, the mobile unit can experience as short a service interruption as possible, including eliminating it entirely in some circumstances.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A method of handling a discontinuation of wireless communication service from a first wireless access device, the first wireless access device having a first basic service set identifier (BSSID) and communicating with a first plurality of mobile units using a first channel, the method comprising:
transmitting a first service notice from a second wireless access device using the first channel, the first service notice containing information instructing the first plurality of mobile units to transfer to a second channel for wireless communication service; and
providing wireless communication service from the second wireless access device to the first plurality of mobile units using the second channel.

2. The method of claim 1, further comprising detecting the discontinuation of wireless communication service from the first wireless access device and wherein transmitting the first service notice is performed in response to detecting the discontinuation of wireless communication service from the first wireless access device.

3. The method of claim 2, wherein detecting the discontinuation of wireless communication service from the first wireless access device comprises monitoring the first channel with the second wireless access device for transmission of service information from the first wireless access device and wherein the discontinuation of wireless communication service is detected in response to a cessation of transmission of service information from the first wireless access device.

4. The method of claim 1, wherein transmitting the first service notice from the second wireless access device comprises transmitting the first service notice using the first BSSID.

5. The method of claim 4, wherein providing wireless communication service to the first plurality of mobile units comprises providing service using a second BSSID.

6. The method of claim 1, further comprising:
detecting a resumption of wireless communication service from the first wireless access device; and
transmitting a second service notice from the second wireless access device using the second channel, the second service notice containing information instructing the first plurality of mobile units to resume wireless communication service with the first wireless access device using the first channel.

7. The method of claim 1, further comprising providing wireless communication service to a second plurality of mobile units using a second BSSID and using the second channel.

8. The method of claim 1, wherein transmitting the first service notice comprises transmitting the first service notice repeatedly during an interval.

9. The method of claim 1, wherein transmitting the first service notice comprises transmitting a channel switch announcement primitive.

10. A method of providing wireless communication service to a first plurality of mobile units, the method comprising:
providing wireless communication service from a first wireless access device using a first channel, the first wireless access device controlled by a system controller and communicating with the first plurality of mobile units using a first basic service set identifier (BSSID);
detecting an interruption of wireless communication service from the first wireless access device with the system controller;
transmitting a first channel switch notice from a second wireless access device using the first BSSID and the first channel, the first channel switch notice containing information instructing a first group of the first plurality of mobile units to communicate with the second wireless access device using a second channel; and
providing wireless communication service from the second wireless access device using the second channel.

11. The method of claim 10, wherein providing wireless communication service from the first wireless access device comprises communicating with the first group of the first plurality of mobile devices using the first channel.

12. The method of claim 11, wherein transmitting the first channel switch notice comprises transmitting information instructing the first group of the first plurality of mobile devices to communicate with the second wireless access device using the second channel.

13. The method of claim 10, further comprising:
detecting a resumption of wireless communication service from the first wireless access device with the system controller; and
transmitting a second channel switch notice from the second wireless access device using the second channel, the second channel switch notice containing information instructing the first group of the first plurality of mobile units to communicate with the first wireless access device using the first channel.

14. The method of claim 10, further comprising providing wireless communication service to a second plurality of mobile units from the second wireless access device, the second wireless access device using a second BSSID.

15. The method of claim 10, further comprising:
transmitting a third channel switch notice from a third wireless access device using the first BSSID, the third channel switch notice containing information instructing a second group of the first plurality of mobile units to communicate with the third wireless access device using a third channel; and
providing wireless communication service from the third wireless access device using the third channel.

16. A wireless access device for providing wireless communication service to a mobile unit, the wireless access device adapted to:
detect a discontinuation of wireless communication service from a nearby wireless access device, the nearby wireless access device providing communication to the mobile unit using a first basic service set identifier (BSSID) and communicating with the mobile unit using a first channel;
transmit a first service notice from the wireless access device using the first channel and the first BSSID, the first service notice containing information instructing the mobile unit to transfer to a second channel for wireless communication service; and
provide wireless communication service to the mobile unit using the second channel.

17. The wireless access device of claim 16, wherein the wireless access device is further adapted to communicate with the mobile unit using the first BSSID.

18. The wireless access device of claim 17, wherein the wireless access device is further adapted to transmit a second channel switch notice in response to detecting a resumption of service from the nearby wireless access device, the second channel switch notice conveying information instructing the mobile unit to communicate with the nearby wireless access device using the first channel.

19. The wireless access device of claim 16, wherein the first channel switch notice comprises a channel switch announcement primitive.

20. The wireless access device of claim 16, wherein the second wireless access device is further adapted to provide wireless service to a second mobile unit using the second channel and a second BSSID.
